(19) United States
(12) Patent Application Publication
(10) Pub. No.: US 2025/0323563 A1
(43) Pub. Date: Oct. 16, 2025

(54) POWER SUPPLY CONTROL PROTECTION SYSTEM AND CONTROL PROTECTION METHOD

(71) Applicant: Sungrow Power Supply Co., Ltd., Hefei (CN)

(72) Inventors: Anan Xu, Hefei (CN); Wubo Wanag, Hefei (CN); Bing Zhang, Hefei (CN); Changyou Wang, Hefei (CN)

(73) Assignee: Sungrow Power Supply Co., Ltd., Hefei (CN)

(21) Appl. No.: 18/871,467

(22) PCT Filed: Apr. 24, 2023
(86) PCT No.: PCT/CN2023/090208

§ 371 Date: Dec. 3, 2024

(30) Foreign Application Priority Data
Sep. 2, 2022 (CN) 202211071323.0

(51) Int. Cl. H02M 1/00; H02M 1/32; H02M 3/155

(52) U.S. Cl. CPC H02M 1/0006; H02M 1/325; H02M 3/155

(57) ABSTRACT

A power supply control protection system includes: a switching power supply, a main controller, an auxiliary controller, a sampling circuit and an energy storage element, the switching power supply is used for supplying power to the sampling circuit, the main controller and the auxiliary controller; the energy storage element is used for providing an auxiliary power supply for the sampling circuit, the main controller and the auxiliary controller; the sampling circuit has a self-checking function and sends a self-checking result to at least one of the main controller and the auxiliary controller; when the self-checking result indicates that the sampling circuit is normal, the main controller or the auxiliary controller controls a converter to work; and the main controller and the auxiliary controller communicate with each other. When a switching power supply cannot normally supply power, an energy storage element supplies power to a circuit.

This application is a national stage filing under 35 U.S.C. § 371 of International Patent Application Serial No. PCT/CN2023/090208, filed Apr. 24, 2023, which claims priority to Chinese Patent Application No. 202211071323.0, titled “POWER SUPPLY CONTROL PROTECTION SYSTEM AND CONTROL PROTECTION METHOD”, filed with the China National Intellectual Property Administration on Sep. 2, 2022. The contents of these applications are incorporated herein by reference in their entirety.

### FIELD

The present application relates to the technical field of new energy power generation, and in particular to a power supply control protection system and a control protection method.

### BACKGROUND

With the development of new energy, photovoltaic power generation is becoming widely used. Typically, multiple photovoltaic strings are connected in parallel. Each photovoltaic string includes multiple photovoltaic modules connected in series, and each photovoltaic module includes multiple solar cells connected in series. Diodes are reversely connected between positive and negative output terminals of the photovoltaic module and corresponding connection positions of the cells.

For safety, a trip switch is connected between the photovoltaic strings and a converter. When a fault is detected, a trip command is issued to make the trip switch disconnect, and the trip switch serves as a protection device. Therefore, redundant control is needed for a control circuit of the trip switch from the perspective of safety standards. According to a conventional design solution, all of a switched-mode power supply, a controller and a sampling circuit are doubled, leading to complicated circuits and high costs.

### SUMMARY

In view of this, a power supply control protection system and a control protection method are provided in the present application, so as to reduce costs and simplify circuits while performing redundant control on a trip switch.

To solve the above problem, a power supply control protection system is provided in the present application, including a switched-mode power supply, a main controller, an auxiliary controller, a sampling circuit and an energy storage element,
the switched-mode power supply is configured to supply power to the sampling circuit, the main controller and the auxiliary controller;
the energy storage element is an auxiliary power supply for the sampling circuit, the main controller and the auxiliary controller;
the sampling circuit has a self-detection function, and is configured to send a self-detection result to at least one of the main controller and the auxiliary controller;
in a case that the self-detection result shows that the sampling circuit operates normally, the main controller or the auxiliary controller is configured to control a converter to operate; and
the main controller and the auxiliary controller are in communication with each other.

A control protection method for a power supply system is further provided in the present application, where
the power supply system includes a switched-mode power supply, a main controller, an auxiliary controller, a sampling circuit and an energy storage element, and the main controller and the auxiliary controller are in communication with each other, where
the method includes:
controlling the switched-mode power supply to supply power to the sampling circuit, the main controller and the auxiliary controller in a case that the switched-mode power supply operates normally, and controlling the energy storage element to supply power to the sampling circuit, the main controller and the auxiliary controller in a case that the switched-mode power supply operates abnormally; and
performing, by the sampling circuit, self-detection, and controlling, by the main controller or the auxiliary controller, a converter to operate in a case that a self-detection result shows that the sampling circuit operates normally.

It can be seen that, the present application has the following beneficial effects.

The power supply control protection system provided in the present application includes the converter, the switched-mode power supply, the main controller, the auxiliary controller, the sampling circuit, the trip switch and the energy storage element. The energy storage clement is provided to serve as the auxiliary power supply to ensure effective and reliable operation of a fault isolation circuit. If the switched-mode power supply cannot supply power normally, the energy storage element supplies power to the controllers and the sampling circuit, so as to ensure normal sampling and reliable control of the power supply system, thereby ensuring a reliable operation of the fault isolation circuit. For example, the power supply system is a photovoltaic system. When the photovoltaic string is connected reversely, the fault isolation circuit can be reliably disconnected, i.e., can trip automatically, so as to prevent the photovoltaic string connected reversely from burning up. Moreover, the sampling circuit has the self-detection function, and the self-detection result is sent to at least one of the two controllers. In this way, a fault of the sampling circuit can be detected timely, and therefore there is no need to provide two sampling circuits, thereby reducing the cost.

### BRIEF DESCRIPTION OF THE DRAWINGS

FIG. 1 is a schematic view of a power supply control protection system according to the present application;

FIG. 2 is a schematic view of a specific power supply control protection system according to an embodiment of the present application;

FIG. 3 is a schematic view of another power supply control protection system according to an embodiment of the present application;

FIG. 4 is a schematic view of further another power supply control protection system according to an embodiment of the present application;

FIG. 5 is a schematic view of further another power supply control protection system according to an embodiment of the present application;

FIG. 6 is a schematic view of a power supply control protection system with a mutual detection device according to an embodiment device present application;

FIG. 7 is a schematic view of a photovoltaic system in correspondence with the power supply control protection system according to an embodiment of the present application; and

FIG. 8 is a flowchart of a control protection method for a power supply system according to an embodiment of the present application.

### DETAILED DESCRIPTION OF THE EMBODIMENTS

An application scenario of technical solutions according to the present application is described hereinafter, so that those skilled in the art can better understand the technical solutions provided in embodiments of the present application.

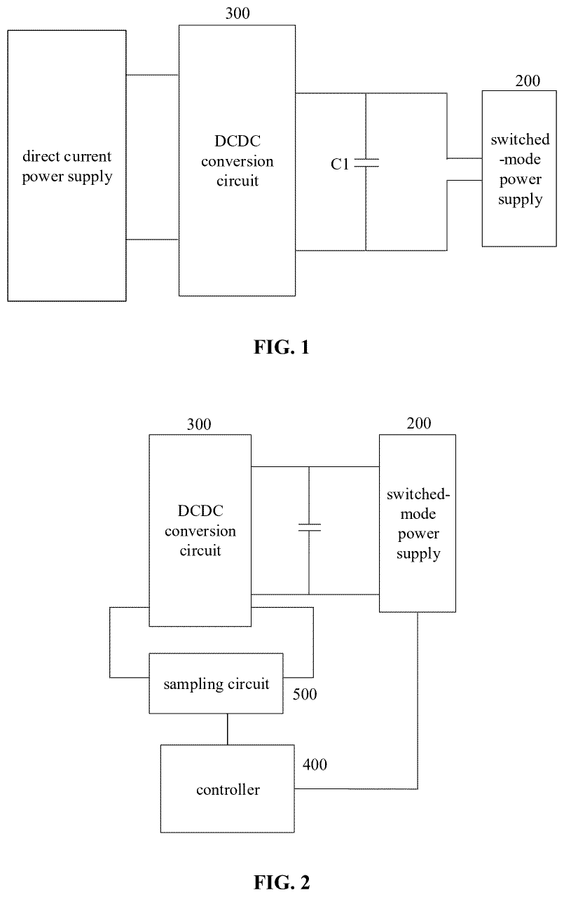

Referring to FIG. 1, FIG. 1 is a schematic view of a power supply control protection system according to the present application.

The power supply control protection system includes a converter and a switched-mode power supply 200 apart from a photovoltaic string.

The specific type of a direct current power supply is not limited in the present application. For example, the direct current power supply may be a photovoltaic string, a wind turbine, or an energy storage battery. If the direct current power supply is the photovoltaic string, then the power supply system is a photovoltaic system.

The converter includes a DCDC conversion circuit as an example for description. It may be appreciated that, the converter may include a DCDC conversion circuit and a DCAC conversion circuit.

The switched-mode power supply 200 serves as an auxiliary power supply for the power supply system, and supplies power from the DCDC conversion circuit 300. The switched-mode power supply 200 is for supplying power to a control circuit (not shown in the drawings). For example, the control circuit generally includes a controller.

Referring to FIG. 2, besides the switched-mode power supply 200, the power supply control protection system further includes a sampling circuit 500 and a controller 400. Redundant control is needed from the perspective of safety standards. According to a conventional design solution, all the switched-mode power supply 200, the controller 400 and the sampling circuit 500 are doubled, leading to complicated circuits and high costs.

Instead of two switched-mode power supplies, the energy storage element is provided according to embodiments of the present application to serve as the auxiliary power supply, so as to simplify the circuits and reduce the costs. The energy storage clement has a simpler structure than the switched-mode power supply, thereby achieving lower cost.

The embodiments of the present application are further described in detail hereinafter in conjunction with the accompanying drawings and specific examples, so that the purpose, features and advantages of the present application are more clear and understandable.

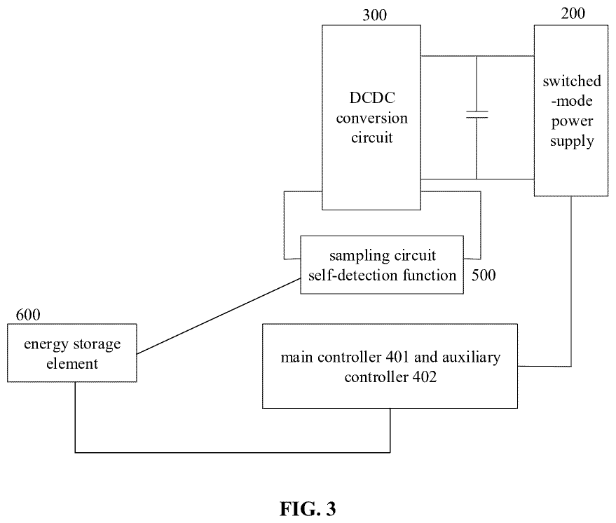

Referring to FIG. 3, FIG. 3 is a schematic view of another power supply control protection system according to an embodiment of the present application.

A power supply control protection system provided in the present embodiment includes a converter, a switched-mode power supply 200, a main controller 401, an auxiliary controller 402, a sampling circuit 500 and an energy storage element 600.

The converter still includes the DCDC conversion circuit 300 as an example for description in the present embodiment.

The converter is configured to supply power from a direct current power supply to the switched-mode power supply 200.

The switched-mode power supply 200 is configured to supply power to the sampling circuit 500, the main controller 401 and the auxiliary controller 402.

The auxiliary controller 600 is an auxiliary power supply for the sampling circuit 500, the main controller 401 and the auxiliary controller 402.

The energy storage element 600 may be an electrical element that has a function of energy storage, such as a capacitor or a battery, which is not specifically limited in the embodiments of the present application. The energy storage element 600 has a simpler structure and lower cost than the switched-mode power supply 200. An output voltage of the energy storage element 600 may be determined according to demands of an electrical load.

The sampling circuit 500 has a self-detection function, and sends a self-detection result to at least one of the main controller 401 and the auxiliary controller 402.

With the self-detection function of the sampling circuit 500, it can be detected timely whether the sampling circuit 500 operates normally. Therefore, only one sampling circuit 500 is needed. The other one of the two sampling circuits 500 can be removed, so as to reduce the cost of the power supply system.

In a case that the self-detection result shows that the sampling circuit 500 operates normally, the main controller 401 or the auxiliary controller 402 controls the converter to operate. The main controller 401 and the auxiliary controller 402 are in communication with each other.

Since the main controller 401 and the auxiliary controller 402 are in communication with each other, the self-detection result of the sampling circuit 500 may be sent to only one of the two controllers, and one of the controllers receiving the self-detection result informs the other one of the controllers. The self-detection result may be sent to both the two controllers.

According to the power supply control protection system provided in the embodiments of the present application, the energy storage element 600 supplies power to the controllers and the sampling circuit if the switched-mode power supply 200 cannot supply power normally, so as to ensure normal sampling and reliable control of the power supply system. Moreover, the sampling circuit has the self-detection function, and sends the self-detection result to at least one of the two controllers. In this way, a fault of the sampling circuit can be detected timely, and therefore there is no need to provide two sampling circuits, thereby reducing the cost.

A specific implementation is described hereinafter, and the power supply system further includes a trip switch. Since the trip switch and the controllers require different voltages, two energy storage elements 600 may be provided in correspondence with two auxiliary power supplies. The implementation is described in detail hereinafter in conjunction with the drawings. The trip switch is also referred to as a circuit breaker.

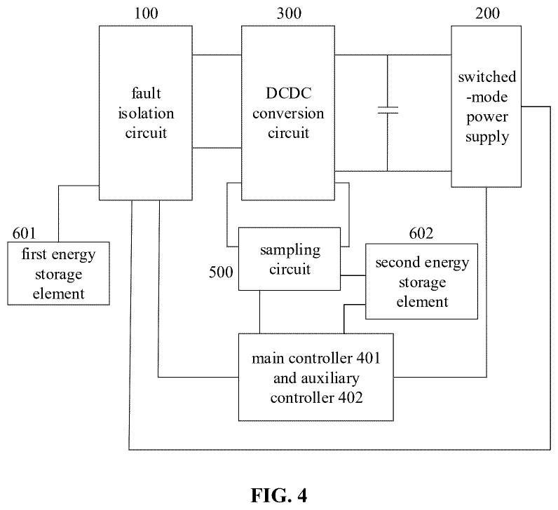

Referring to FIG. 4, FIG. 4 is a schematic view of further another power supply control protection system according to an embodiment of the present application.

In the power supply control protection system provided in the present embodiment, the energy storage element includes a first energy storage element 601 and a second energy storage element 602.

The first energy storage element 601 is an auxiliary power supply for the trip switch 100.

The second energy storage element 602 is an auxiliary power supply for the sampling circuit 500, the main controller 401 and the auxiliary controller 402.

A voltage of the first energy storage element 601 is higher than a voltage of the second energy storage element 602.

Since the trip switch 100 and the controllers are both powered by low voltages, there is no need to provide an additional auxiliary switched-mode power supply. That is, the other one of the two switched-mode power supplies is unnecessary. The first energy storage element 601 for the trip switch 100 according to the present embodiment may include at least one of energy storage elements, such as an energy storage capacitor, a rechargeable battery, a lithium battery or the like. In an example, the voltage may be 12V.

The second energy storage element 602 includes at least one of a supercapacitor, an electrolytic capacitor, a rechargeable battery and a lithium battery. In an example, the voltage may be 5V.

The first energy storage element 601 and the second energy storage element 602 are not affected by the reversely connected photovoltaic string. Therefore, when the switched-mode power supply 200 cannot supply power normally, the first energy storage element 601 supplies power to the trip switch 100, and the second energy storage element 602 supplies power to the sampling circuit 500, the main controller 401 and the auxiliary controller 402.

The sampling circuit of the power supply control protection system according to this embodiment of the present application has a self-detection function, so as to ensure the safety and reliability of the power supply control protection system. That is, the controllers control a fault isolation switch to trip when the sampling circuit operates abnormally. Detailed description is provided hereinafter in conjunction with the drawings.

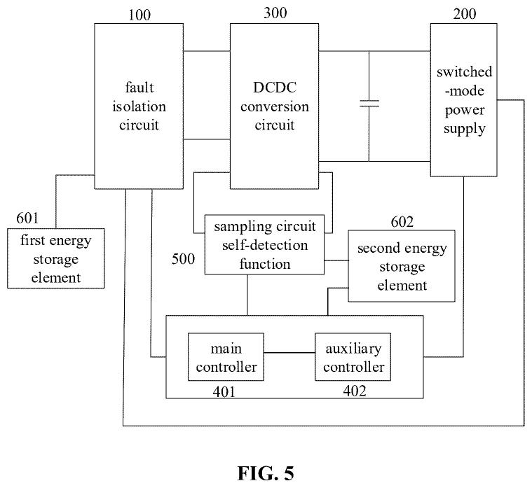

Referring to FIG. 5, FIG. 5 is a schematic view of further another power supply control protection system according to an embodiment of the present application.

According to the power supply control protection system provided in the present embodiment, the sampling circuit 500 has a self-detection function, and sends a self-detection result to at least one of the main controller 401 and the auxiliary controller 402.

In a case that the self-detection result shows that the sampling circuit operates normally, the main controller 401 or the auxiliary controller 402 controls the converter to operate.

The main controller 401 and the auxiliary controller 402 are in communication with each other. That is, the sampling circuit 500 sends the self-detection result to the main controller 401 and the auxiliary controller 402, or only the main controller 401, or only the auxiliary controller 402. Since the two controllers are in communication with each other, the one of the two controllers that receives the self-detection result can inform the other one through communication when the self-detection result 500 sends the self-detection result only to one of the two controllers.

In a case that one of the main controller 401 and the auxiliary controller 402 operates abnormally, the other of the main controller 401 and the auxiliary controller 402 that operates normally controls the trip switch 100 to trip. That is, if a fault occurs on one of the main controller 401 and the auxiliary controller 402, then the trip switch 100 needs to open to ensure the safety of the power supply system.

The converter can operate normally only when both the two controllers operate normally and the self-detection result of the sampling circuit 500 indicates that the self-detection result 500 operates normally. For example, the DCAC conversion circuit following the DCDC conversion circuit is connected to the grid.

According to the power supply control protection system provided in the present application, the sampling circuit has the self-detection function, thereby ensuring the accuracy of the sampling structure, and ensuring the safety of the power supply system. Therefore, there is no need to provide two sampling circuits. The circuits are further simplified, and the cost is further reduced.

The sampling circuit described hereinabove can send the self-detection result to one of the controllers. If this controller operates abnormally, then it cannot determine whether the sampling circuit operates normally. Therefore, a mutual detection device is added between the main controller and the auxiliary controller to further ensure the safety of the power supply system. Detailed description is provided hereinafter in conjunction with the drawings. It may be appreciated that, the mutual detection device may not be provided if the sampling circuit sends the self-detection result to both of the controllers.

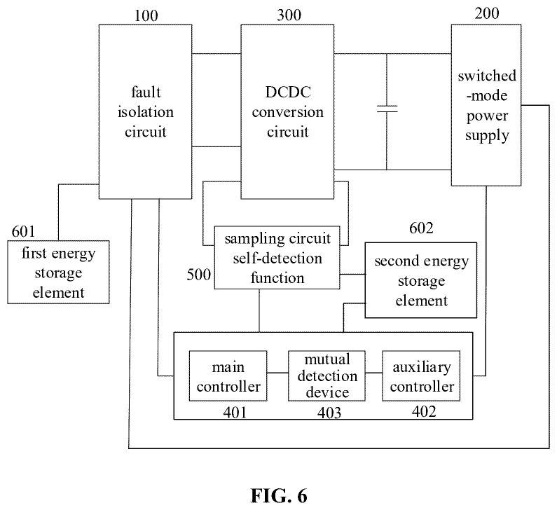

Referring to FIG. 6, FIG. 6 is a schematic view of a power supply control protection system with the mutual detection device according to an embodiment device present application.

The power supply control protection system provided in the present embodiment further includes a mutual detection device 403 connected between the main controller 401 and the auxiliary controller 402.

The mutual detection device 403 is for detecting whether the main controller 402 and the auxiliary controller 401 operate in a normal state, and sending a state result to the main controller 401 and the auxiliary controller 402.

In a case that the main controller 401 or the auxiliary controller 402 operates abnormally, the other controller that operates normally controls the trip switch 100 to trip, or, sends a trip command, i.e., a disconnection command, to the trip switch 100, thereby ensuring the safety of the power supply system.

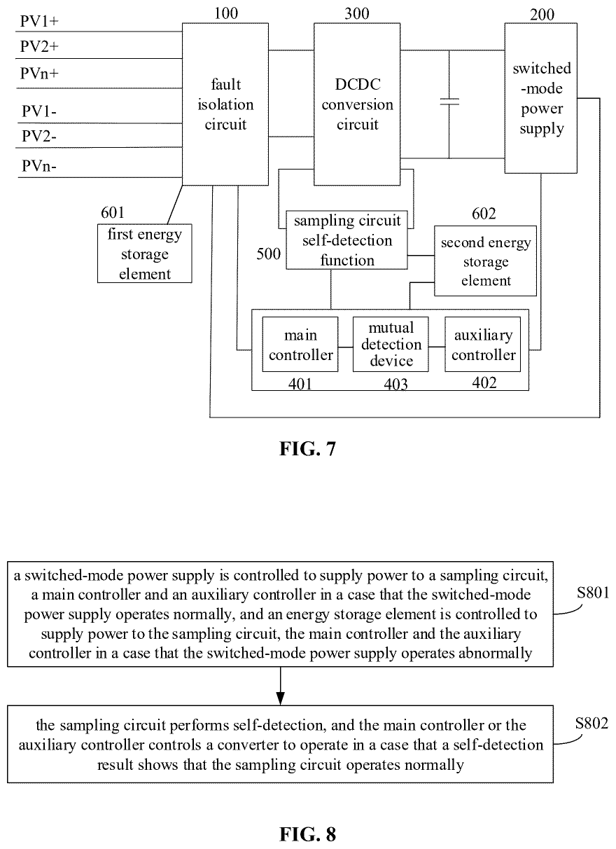

Referring to FIG. 7, FIG. 7 is a schematic view of a photovoltaic system in correspondence with the power supply control protection system according to an embodiment of the present application.

In the power supply control protection system provided in the present embodiment, the direct current power supply includes multiple photovoltaic strings that are connected in parallel. As an example, an input terminal of the trip switch 100 is connected to n photovoltaic strings. Generally, the n photovoltaic strings are connected in parallel. That is, PV1+, PV2+, . . . ,Pvn+ are connected to each other, and PV1−, PV2−, . . . , Pvn− are connected to each other.

The switched-mode power supply 200 serves as the auxiliary power supply for the photovoltaic system to supply power to the trip switch 100 of the control circuit. The switched-mode power supply 200 is powered by the photovoltaic strings. For example, the switched-mode power supply 200 may serve as a switched-mode power supply inside an inverter of the photovoltaic system, or may be located outside the inverter. The converter is for supplying power from at least one of the multiple photovoltaic strings to the switched-mode power supply.

Based on the power supply control protection system according to the above power supply control protection system, a control protection method for a power supply system is further provided in an embodiment of the present application, which is described in detail hereinafter in conjunction with the drawings.

Referring to FIG. 8, FIG. 8 is a flowchart of a control protection method for a power supply system according to an embodiment of present application.

A control protection method for a power supply system is further provided in the present application. The power supply system includes a switched-mode power supply, a main controller, an auxiliary controller, a sampling circuit and an energy storage element, and the main controller and the auxiliary controller are in communication with each other.

The method includes the following steps.

In step S801, the switched-mode power supply is controlled to supply power to the sampling circuit, the main controller and the auxiliary controller in a case that the switched-mode power supply operates normally, and the energy storage element is controlled to supply power to the sampling circuit, the main controller and the auxiliary controller in a case that the switched-mode power supply operates abnormally.

In step S802, the sampling circuit performs self-detection, and the main controller or the auxiliary controller controls the converter to operate in a case that a self-detection result shows that the sampling circuit operates normally.

The energy storage element is provided to serve as the auxiliary power supply to ensure effective and reliable operation of a fault isolation circuit. If the switched-mode power supply cannot supply power normally, the energy storage element supplies power to the controllers and the sampling circuit, so as to ensure normal sampling and reliable control of the power supply system, thereby ensuring the reliable operation of the fault isolation circuit. For example, the power supply system is a photovoltaic system. When the photovoltaic string is connected reversely, the fault isolation circuit can be reliably disconnected, i.e., can trip automatically, so that the photovoltaic string being connected reversely is prevented from burning up. Moreover, the sampling circuit has the self-detection function, and the self-detection result is sent to at least one of the two controllers. In this way, a fault of the sampling circuit can be detected timely, and therefore there is no need to provide two sampling circuits, thereby reducing the cost.

The method further includes the following steps.

At least one of the main controller and the auxiliary controller receives the self-detection result sent by the sampling circuit, and one of the main controller and the auxiliary controller that receives the self-detection result sends the self-detection result to the other one of the main controller and the auxiliary controller.

In a case that the self-detection result shows that the sampling circuit operates normally, the main controller or the auxiliary controller controls a converter to operate.

The main controller and the auxiliary controller may both receive the self-detection result to be further reliably informed whether the sampling circuit operates normally.

The power supply system further includes a trip switch connected between a direct current power supply and the converter.

The method further includes the following steps.

In a case that one of the main controller and the auxiliary controller operates abnormally, the other controller that operates normally controls the trip switch to trip.

In a case that the main controller or the auxiliary controller operates abnormally, the other controller that operates normally controls the trip switch to trip, or, sends a trip command, i.e., a disconnection command, to the trip switch, thereby ensuring the safety of the power supply system.

The method further includes the following steps.

A mutual detection device detects whether the main controller and the auxiliary controller are in a normal state, and the normal one of the main controller and the auxiliary controller controls the trip switch to trip in a case that the main controller or the auxiliary controller operates abnormally.

Based on the above description of the disclosed embodiments, those skilled in the art are capable of carrying out or using the present application. It is obvious for those skilled in the art to make many modifications to these embodiments. The general principle defined herein may be applied to other embodiments without departing from the spirit or scope of the present application. Therefore, the present application is not limited to the embodiments illustrated herein, but should be defined by the broadest scope consistent with the principle and novel features disclosed herein.

1. A power supply control protection system, comprising a switched-mode power supply, a main controller, an auxiliary controller, a sampling circuit and an energy storage element, wherein
the switched-mode power supply is configured to supply power to the sampling circuit, the main controller and the auxiliary controller;
the energy storage element is an auxiliary power supply for the sampling circuit, the main controller and the auxiliary controller;
the sampling circuit has a self-detection function, and is configured to send a self-detection result to at least one of the main controller and the auxiliary controller;
in a case that the self-detection result shows that the sampling circuit operates normally, the main controller or the auxiliary controller is configured to control a converter to operate; and
the main controller and the auxiliary controller are in communication with each other.

2. The system according to claim 1, comprising a trip switch connected between a direct current power supply and the converter, wherein in a case that one of the main controller and the auxiliary controller operates abnormally, the other of the main controller and the auxiliary controller that operates normally is configured to control the trip switch to trip.

3. The system according to claim 2, comprising a mutual detection device connected between the main controller and the auxiliary controller, wherein
the mutual detection device is configured to detect whether the main controller and the auxiliary controller operate in a normal state, and send a state result to the main controller and the auxiliary controller, and the trip switch is controlled to trip in a case that the main controller or the auxiliary controller operates abnormally.

4. The system according to claim 2, wherein
the energy storage element comprises a first energy storage element and a second energy storage element,
the first energy storage element is an auxiliary power supply for the trip switch; and
the second energy storage element is an auxiliary power supply for the sampling circuit, the main controller and the auxiliary controller.

5. The system according to claim 4, wherein a voltage of the first energy storage element is higher than a voltage of the second energy storage element.

6. The system according to claim 4, wherein
the first energy storage element comprises at least one of an energy storage capacitor, a rechargeable battery and a lithium battery, and
the second energy storage element comprises at least one of a supercapacitor, an electrolytic capacitor, a rechargeable battery and a lithium battery.

7. The system according to claim 1, wherein the converter comprises a DCDC converter, and an input terminal of the DCDC converter is connected to a direct current power supply through a trip switch.

8. The system according to claim 6, wherein the direct current power supply comprises a plurality of photovoltaic strings that are connected in parallel.

9. The system according to claim 7, wherein the converter is configured to supply power from at least one of photovoltaic string to the switched-mode power supply.

10. The system according to claim 7, wherein an output terminal of the DCDC converter is connected to the switched-mode power supply, and the switched-mode power supply is configured to supply power from the output terminal of the DCDC converter.

11. The system according to claim 1, wherein the switched-mode power supply is located inside the converter.

12. A control protection method for a power supply system, wherein
the power supply system comprises a switched-mode power supply, a main controller, an auxiliary controller, a sampling circuit and an energy storage element, and the main controller and the auxiliary controller are in communication with each other, wherein
the method comprises:
controlling the switched-mode power supply to supply power to the sampling circuit, the main controller and the auxiliary controller in a case that the switched-mode power supply operates normally, and controlling the energy storage element to supply power to the sampling circuit, the main controller and the auxiliary controller in a case that the switched-mode power supply operates abnormally; and
performing, by the sampling circuit, self-detection, and controlling, by the main controller or the auxiliary controller, a converter to operate in a case that a self-detection result shows that the sampling circuit operates normally.

13. The method according to claim 12, comprising: receiving, by at least one of the main controller and the auxiliary controller, the self-detection result sent by the sampling circuit, and sending, by one of the main controller and the auxiliary controller that receives the self-detection result, the self-detection result to the other one of the main controller and the auxiliary controller.

14. The method according to claim 12, wherein
the power supply system comprises a trip switch connected between a direct current power supply and the converter, wherein
the method comprises:
detecting, by a mutual detection device, whether the main controller and the auxiliary controller operate in a normal state, and controlling, by a normal one of the main controller and the auxiliary controller, the trip switch to trip in a case that the other one of the main controller or the auxiliary controller operates abnormally.

15. The method according to claim 12, comprising:
receiving, by both of the main controller and the auxiliary controller, the self-detection result.

16. The system according to claim 3, wherein
the energy storage element comprises a first energy storage element and a second energy storage element,
the first energy storage element is an auxiliary power supply for the trip switch; and
the second energy storage element is an auxiliary power supply for the sampling circuit, the main controller and the auxiliary controller.

17. The system according to claim 2, wherein the converter comprises a DCDC converter, and an input terminal of the DCDC converter is connected to a direct current power supply through a trip switch.

18. The system according to claim 3, wherein the converter comprises a DCDC converter, and an input terminal of the DCDC converter is connected to a direct current power supply through a trip switch.

19. The system according to claim 4, wherein the converter comprises a DCDC converter, and an input terminal of the DCDC converter is connected to a direct current power supply through a trip switch.

20. The system according to claim 2, wherein the switched-mode power supply is located inside the converter.
